(19) United States
(12) Patent Application Publication
(10) Pub. No.: US 2021/0093097 A1
(43) Pub. Date: Apr. 1, 2021

(54) Furniture Protector System

(71) Applicant: Floppy Ears Design, LLC, Kennebunk, ME (US)

(72) Inventor: Jeffrey E. Canning, Kennebunk, ME (US)

(21) Appl. No.: 17/029,876

(22) Filed: Sep. 23, 2020

Related U.S. Application Data
(60) Provisional application No. 62/906,326, filed on Sep. 26, 2019.

(51) Int. Cl. A47C 31/11; A47C 31/00; B32B 5/02

(52) U.S. Cl. CPC A47C 31/113; A47C 31/116; A47C 31/007; B32B 5/02; B32B 2307/7265; B32B 2307/724; B32B 2479/00; B32B 2307/7145; B32B 2255/02; B32B 2250/03

(57) ABSTRACT

The protector protects the furniture from stains and wear. The protector consists of two or more of sections. The sections may be attached using a number of techniques. The sections may include a first attachment portion and a second attachment portion. The sections may be attached by attaching the first attachment portion to the second attachment portion. The protector may include sections of different shapes which may be attached to cover furniture of different shapes. The section shapes may include a left arm section, a right arm section, an armless chair section, a corner section, an armless loveseat section, and an ottoman section. The sections may include a retention portion to hold the protector and sections onto the furniture. The sections may include one or more layers.

### CROSS-REFERENCE TO RELATED APPLICATIONS

This patent application claims the benefit of U.S. Provisional Patent Application No. 62/906,326, filed Sep. 26, 2019, which is incorporated herein by reference.

### BACKGROUND OF THE INVENTION

Dogs, cats, and other animals may sit or lay on furniture, such as, sofas or chairs. In order to protect the furniture from stains and wear, a person may want to protect the furniture. One way to protect the furniture is to lay a bed sheet over the furniture. However, the bed sheet may not fit the furniture properly and the bed sheet may not provide adequate protection to the furniture. In addition, the situation may be more difficult with furniture which has an unusual shape or size, such as, a sectional sofa.

### BRIEF SUMMARY OF THE INVENTION

The invention provides a protector for furniture. The protector may protect the furniture from stains and wear. The protector may consist of two or more of sections. When the sections are attached together, they form the protector.

The sections may be attached using a number of techniques. The sections may include a first attachment portion and a second attachment portion. The sections may be attached by attaching the first attachment portion to the second attachment portion. In one embodiment, the first attachment portion may be a daisy chain, and the second attachment portion may be a tie. In another embodiment, the first attachment portion may be a daisy chain, and the second attachment portion may be straps with side release buckles. In other embodiments the attachment portions may include hook and loop fasteners.

The protector may include sections of different shapes which may be attached to cover furniture of different shapes. The section shapes may include a left arm section, a right arm section, an armless chair section, a corner section, an armless loveseat section, and an ottoman section.

The sections may include a retention portion to hold the protector and sections onto the furniture. In one embodiment, the retention portion may be a loop. The retention portion may be inserted between two cushions, between a cushion and the arm rest, between a cushion and the back rest, and/or between other portions of the furniture. In another embodiment the retention portion may be one or more ties. The ties may be knotted to hold the section onto the furniture.

The section may include one or more layers. In one embodiment, the section may include a first layer and a second layer. In another embodiment, the section may include a first layer, a second layer, and a third layer.

### BRIEF DESCRIPTION OF THE SEVERAL VIEWS OF THE DRAWINGS

FIGS. 1-5 show a first embodiment for attaching the sections.

FIG. 6 shows a second embodiment for attaching the sections.

FIG. 7 shows a third embodiment for attaching the sections.

FIGS. 8 and 9 show a fourth embodiment for attaching the sections.

FIGS. 10 and 11 show a fifth embodiment for attaching the sections.

FIG. 12 shows a sixth embodiment for attaching the sections.

FIG. 13 shows a seventh embodiment for attaching the sections.

FIGS. 14 and 15 show an eighth embodiment for attaching the sections.

FIGS. 16 and 17 show a first embodiment of combining the sections.

FIG. 18 shows a first embodiment of a section shape.

FIG. 19 shows a second embodiment of a section shape.

FIG. 20 shows a third embodiment of a section shape.

FIG. 21 shows a fourth embodiment of a section shape.

FIG. 22 shows a fifth embodiment of a section shape.

FIG. 23 shows a sixth embodiment of a section shape.

FIG. 24 shows a piece of furniture.

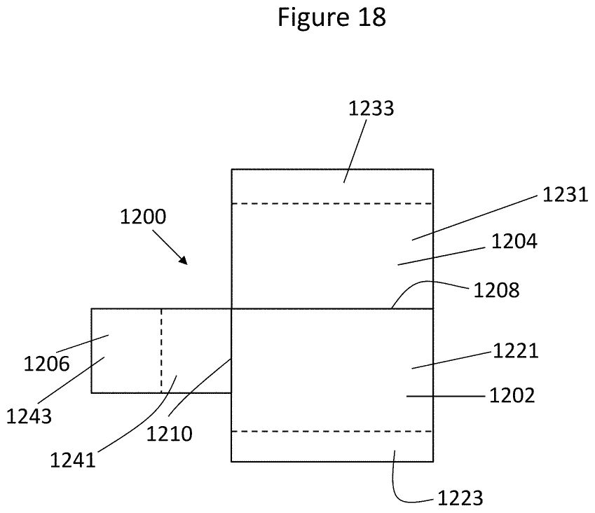

FIG. 25 shows a first embodiment of combining the sections.

FIG. 26 shows a piece of furniture.

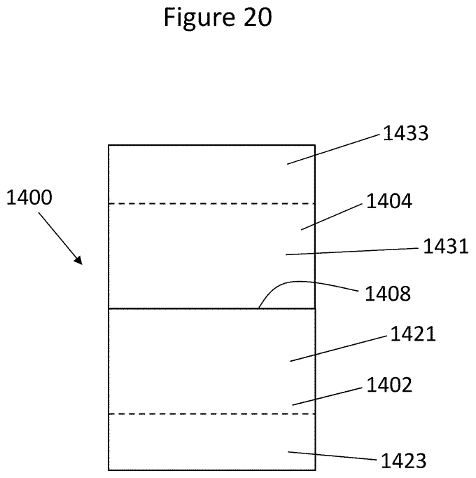

FIG. 27 shows a second embodiment of combining the sections.

FIG. 28 shows a piece of furniture.

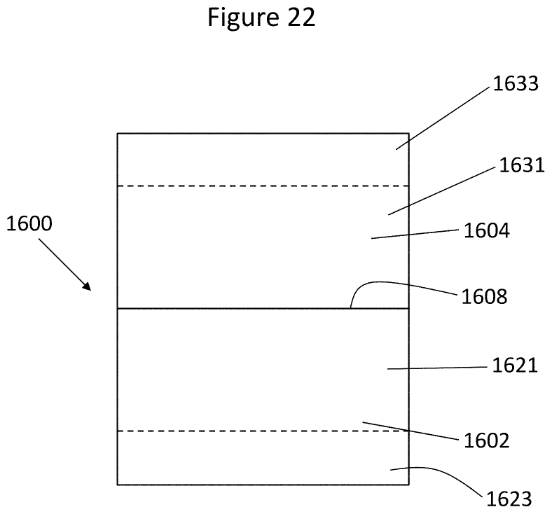

FIG. 29 shows a third embodiment of combining the sections.

FIG. 30 shows a piece of furniture.

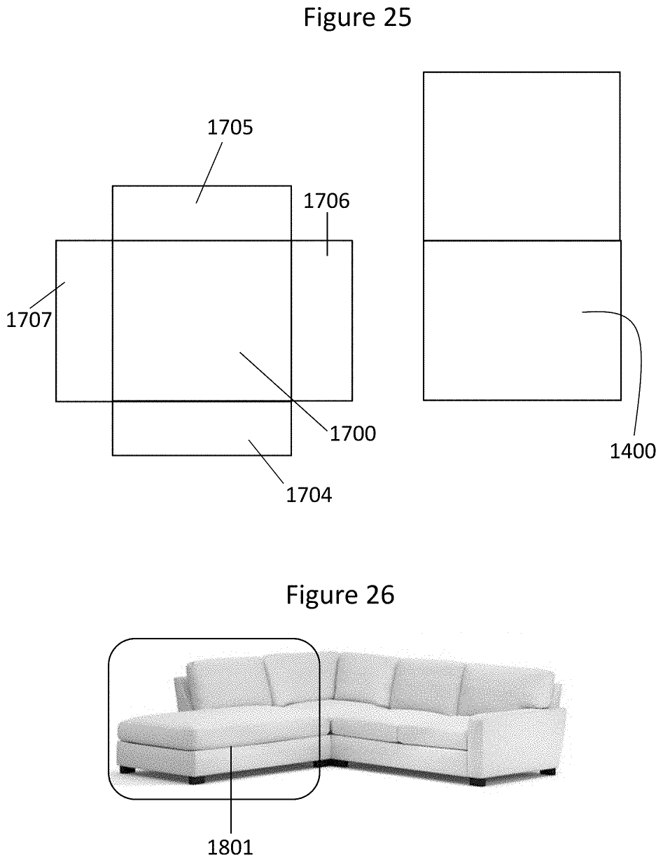

FIG. 31 shows a fourth embodiment of combining the sections.

FIG. 32 shows a piece of furniture.

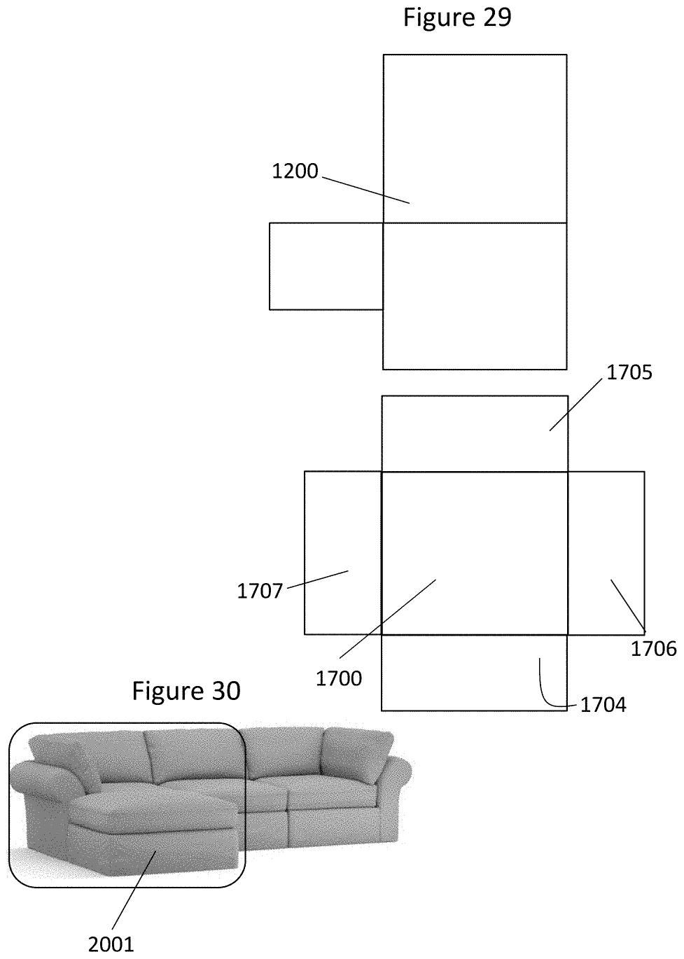

FIGS. 33 and 34 show a fifth embodiment of combining the sections.

FIGS. 35 and 36 show a sixth embodiment of combining the sections.

FIG. 37 shows an embodiment of a retention portion.

FIG. 38 shows a second embodiment of a retention portion.

FIG. 39 shows a first embodiment of a section.

FIG. 40 shows a second embodiment of a section.

### DETAILED DESCRIPTION OF THE INVENTION

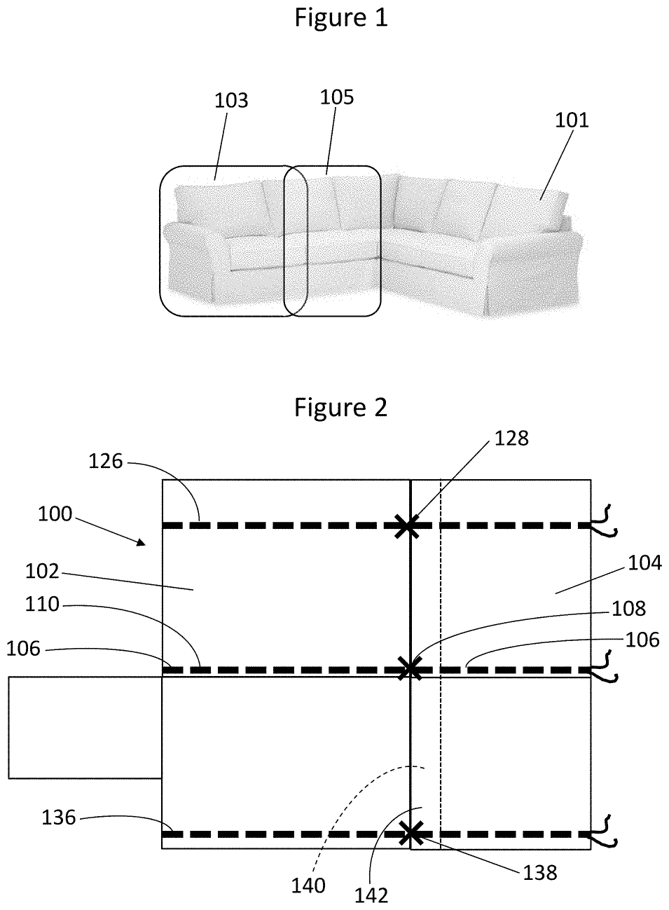

Referring to FIGS. 1 and 2, the protector 100 may consist of two or more of sections 102, 104. When the sections are attached together, they form the protector 100. The protector 100 is used to protect furniture 101, for example, a sofa. For example, section 102 may protect area 103 of the furniture and section 104 may protect area 105 of the furniture. A section 102 of the protector may overlap with another section 104. The shape and construction of the sections are described in subsequent paragraphs.

The sections may be attached using a number of techniques. The techniques are described in the embodiments below.

Referring to FIGS. 2 and 3, the sections may include a first attachment portion 106 and a second attachment portion 108. The sections may be attached by attaching the first attachment portion to the second attachment portion. In one embodiment, the first attachment portion 106 may be a daisy chain 110. Referring to FIG. 3, the daisy chain 110 may be material 112 that is attached to the underside of the section 102. In one embodiment, the material 112 may be attached by sewing. In other embodiments, the material may be attached by gluing, bonding, or other technique. In one embodiment, the material 112 may be attached at one or more locations 114 to the section. The material 112 may be made of cloth, webbing material, strapping material, or other material. The location of the first attachment portion 106 may be in the same location on each section.

Referring to FIG. 4, in one embodiment, the second attachment portion 108 may be a tie 116. The tie 116 may be material 117 that can be tied in a bow, or knot. The material 117 may be made of cloth, webbing material, strapping material, or other material. In one embodiment, the tie 116 may include a first tie 118 and a second tie 120. The ties 118, 120 may be attached to section 102. In one embodiment, the ties 118, 120 may be attached by sewing. In other embodiments, the ties may be attached by gluing, bonding, or other technique.

A section may include one or more first attachment portions and one or more second attachment portions. In one embodiment as shown in FIGS. 2 and 5, a section may include first attachment portions 106, 126, 136 and second attachment portions 108, 128, 138.

Referring to FIGS. 2 and 5, when installing the protector 100, the sections 102, 104 are placed on the furniture 101. A portion 140 of a section 102 may be placed under a portion 142 of adjacent section 104. The first attachment portion 106 may be attached to the second attachment portion 108. In embodiments which include more than one attachment portion, the first attachment portions 106, 126, 136 may be attached to their respective second attachment portions 108, 128, 138. In one embodiment, the ties 118, 120 on section 102 are attached to the daisy chain 110 on the section 104.

In another embodiment, the sections may abut each other at their edges 144, 146. Thus, the sections may not overlap. The first attachment portion 106 may be attached to the second attachment portion 108. In embodiments which include more than one attachment portion, the first attachment portions 106, 126, 136 may be attached to their respective second attachment portions 108, 128, 138. In one embodiment, the ties 118, 120 on section 102 are attached to the daisy chain 110 on the section 104.

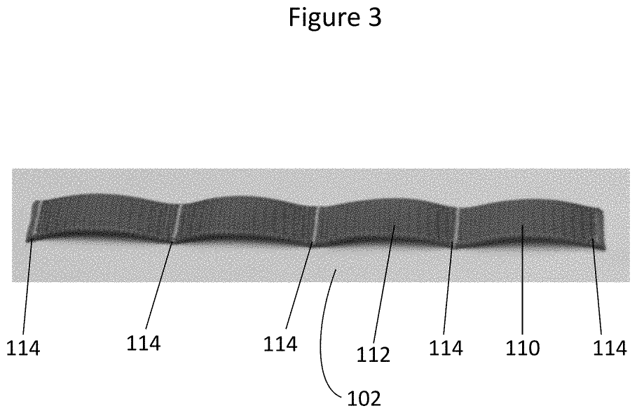

Referring to FIG. 6, another embodiment is shown for attaching the sections. In this embodiment, the section 202 may include a first attachment portion 206 and a second attachment portion 208. The sections may be attached by attaching the first attachment portion 206 to the second attachment portion 208. The first attachment portion 206 may be a daisy chain 210. The second attachment portion 208 may be straps 218, 220 with side release buckles 222, 224. The attachment process may be similar to the ties 118, 120 except that the straps 218, 220 are attached to the daisy chain 210 with side release buckles 222, 224.

A section may include one or more first attachment portions and one or more second attachment portions. A section 202, 204 may include one, two, three, four, five, six or more first attachment portions and one, two, three, four, five, six or more second attachment portions.

In one embodiment, a portion of section 204 may be placed under section 202 as noted above. In another embodiment, the sections 202, 204 may abut each other at their edges as noted above.

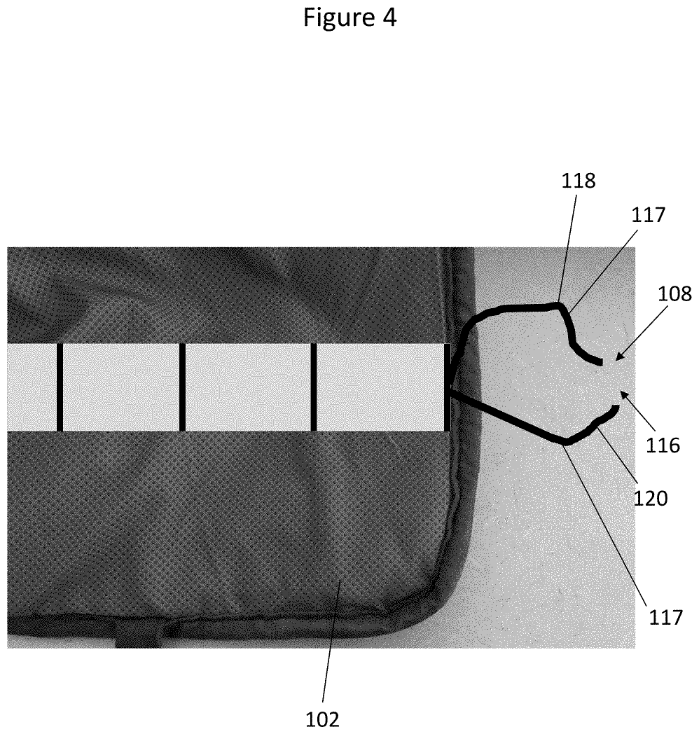

Referring to FIG. 7, another embodiment is shown for attaching the sections. The sections 302, 304 may include a first attachment portion 306 and a second attachment portion 308. The sections 302, 304 may be attached by attaching the first attachment portion 306 to the second attachment portion 308. The attachment portions may be hook and loop fasteners. The hook and loop fasteners may include tiny hooks, and loops. When the two components are pressed together, the hooks catch in the loops and the two pieces fasten or bind temporarily during the time that they are pressed together. One type of hook and loop fasteners are sold under the name Velcro. In one embodiment, the first attachment portion 306 may include hooks and the second attachment portion 308 may include loops. In another embodiment, the first attachment portion 306 may include loops and the second attachment portion 308 may include hooks. In a third embodiment, first attachment portion 306 may include hooks and loops and the second attachment portion 308 may include hooks and loops. The hooks and loops on the first attachment portion 306 engage the hooks and loops on the second attachment portion 308. The attachment portions 306, 308 would be attached to the underside of the sections 302, 304. The attachment portions may be attached at 45 degree angles to assure that the first attachment portion attaches to the second attachment portion. In other embodiments, the attachment portions may be attached vertically and/or horizontally, or at any angle between horizontal and vertical.

In one embodiment, the attachment portions 306, 308 may be attached to the sections by sewing. In other embodiments, the attachment portions 306, 308 may be attached by gluing, bonding, or other technique.

A section may include one or more first attachment portions and one or more second attachment portions. A section 302, 304 may include one, two, three, four, five, six or more first attachment portions and one, two, three, four, five, six or more second attachment portions. In one embodiment as shown in FIG. 7, a section may include first attachment portions 306, 326, 336 and second attachment portions 308, 328, 338.

In one embodiment, a portion of section 304 may be placed under section 302 as noted above. In another embodiment, the sections 302, 304 may abut each other at their edges as noted above.

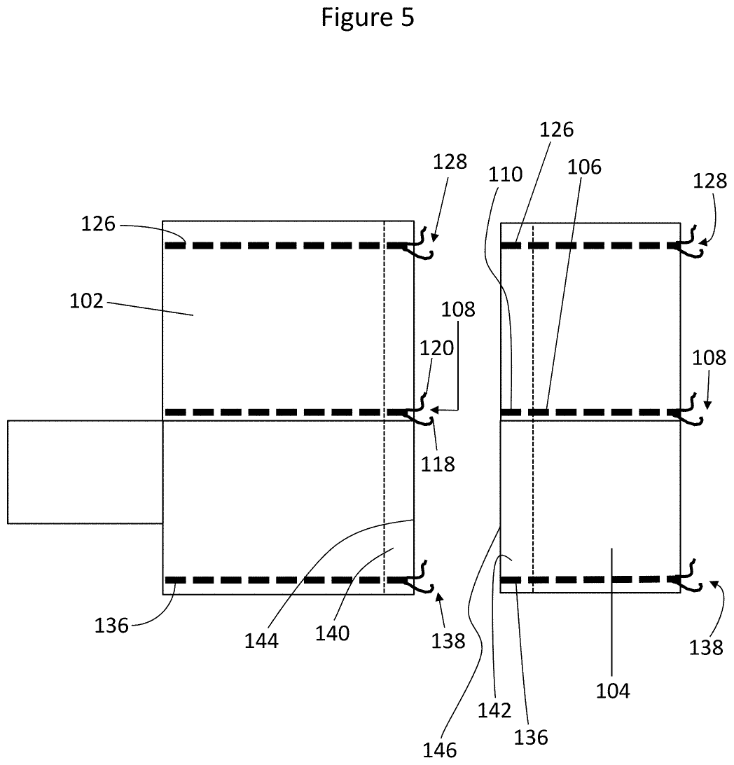

Referring to FIGS. 8 and 9, another embodiment is shown for attaching the sections. In this embodiment, the sections 402, 404 may include a first attachment portion 406 and a second attachment portion 408. The sections 402, 404 may be attached by attaching the first attachment portion 406 to the second attachment portion 408.

In one embodiment, the first attachment portion 406 may be a loop 410. In one embodiment, the loop 410 may be material 412 which is attached to the section 402. In one embodiment, the loop 410 may be attached to the underside of the section. In one embodiment, the material 412 may be attached by sewing. In other embodiments, the material may be attached by gluing, bonding, or other technique. In one embodiment, the material 412 may be attached at one or more locations 414 to the section. The material 412 may be made of cloth, webbing material, strapping material, or other material. The location of the first attachment portion 406 may be in the same location on each section.

Referring to FIGS. 8 and 9, in one embodiment, the second attachment portion 408 may be a tab 416. The tab 416 may be attached to section 404. The tab 416 may be material 418 which is attached to the underside of the section 404. In one embodiment, the material 418 may be attached by sewing. In other embodiments, the material may be attached by gluing, bonding, or other technique. The material 418 may be made of cloth, webbing material, strapping material, or other material. The location of the second attachment portion 408 may be in the same location on each section. The tab 416 may include hook and loop fasteners 420, 422 as described above. The hook and loop fasteners 420, 422 may be attached by sewing. In other embodiments, the fasteners 420, 422 may be attached by gluing, bonding, or other technique.

Referring to FIG. 9, the first attachment portion 406 is attached to the second attachment portion 408 by inserting the tab 416 into the loop 410. In one embodiment, the tab 416 may be inserted into the loop 410 and then the tab 416 is folded over the loop 410 so that the fasteners 420, 422 engage.

A section may include one or more first attachment portions and one or more second attachment portions. A section 402, 404 may include one, two, three, four, five, six or more first attachment portions and one, two, three, four, five, six or more second attachment portions. In one embodiment as shown in FIG. 8, a section may include first attachment portions 406, 407, 426, 427, 436, 437 and second attachment portions 408, 409, 428, 429, 438, 439.

In one embodiment, a portion of section 404 may be placed under section 402 as noted above. In another embodiment, the sections 402, 404 may abut each other at their edges as noted above.

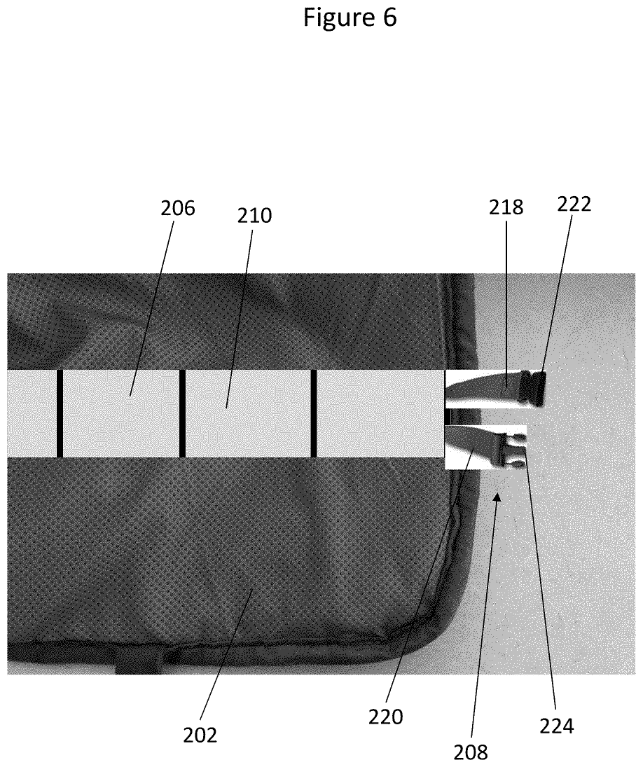

Referring to FIGS. 10 and 11, another embodiment is shown for attaching the sections. In this embodiment, the sections 502, 504 may include a first attachment portion 506 and a second attachment portion 508. The sections 502, 504 may be attached by attaching the first attachment portion 506 to the second attachment portion 508.

In one embodiment, the first attachment portion 506 may be a daisy chain 510. Referring to FIG. 11, the daisy chain 510 may be material 512 that is attached to the underside of the section 502. In one embodiment, the material 512 may be attached by sewing. In other embodiments, the material may be attached by gluing, bonding, or other technique. In one embodiment, the material 512 may be attached at one or more locations 514 to the section. The material 512 may be made of cloth, webbing material, strapping material, or other material. In one embodiment, the first attachment portion 506 may include one or more openings 516. In one embodiment, the opening 516 may be a button hole. The location of the first attachment portion 506 may be in the same location on each section.

Referring to FIGS. 10 and 11, in one embodiment, the second attachment portion 508 may be a tab 518. The tab 518 may be attached to section 504. The tab 518 may include a material 520 which is attached to the underside of the section 504. In one embodiment, the material 520 may be attached by sewing. In other embodiments, the material may be attached by gluing, bonding, or other technique. The material 520 may be made of cloth, webbing material, strapping material, or other material. The location of the second attachment portion 508 may be in the same location on each section. The tab 518 may include a button 522. The button 522 may be sewn onto the tab 518 or attached by another technique.

Referring to FIG. 11, the first attachment portion 506 is attached to the second attachment portion 508 by inserting the button 522 into the opening 516.

A section may include one or more first attachment portions and one or more second attachment portions. A section 502, 504 may include one, two, three, four, five, six or more first attachment portions and one, two, three, four, five, six or more second attachment portions. In one embodiment as shown in FIG. 10, a section may include first attachment portions 506, 507, 526, 527, 536, 537 and second attachment portions 508, 509, 528, 529, 538, 539.

In one embodiment, a portion of section 504 may be placed under section 502 as noted above. In another embodiment, the sections 502, 504 may abut each other at their edges as noted above.

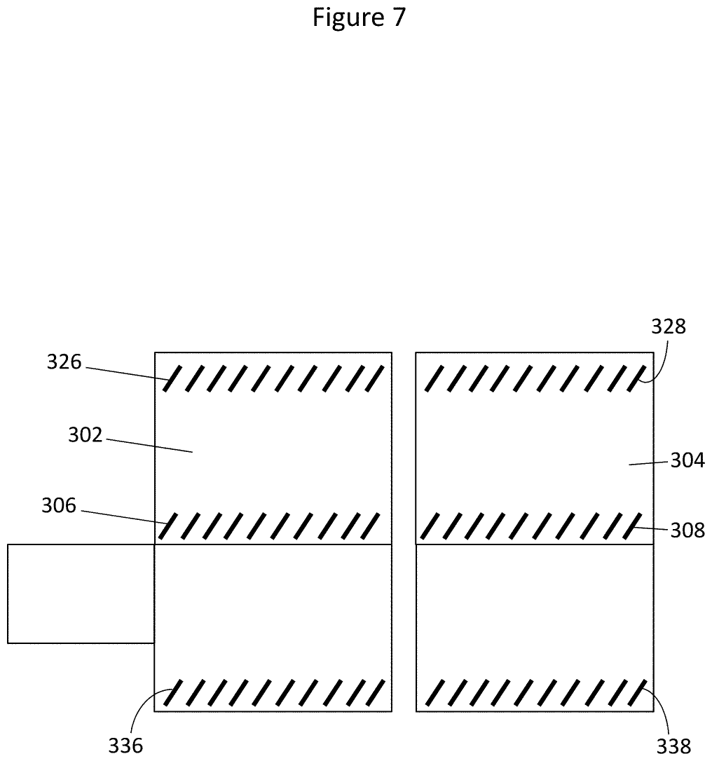

Referring to FIG. 12, another embodiment is shown for attaching the sections. The sections 602, 604 may include a first attachment portion 606 and a second attachment portion 608. The sections 602, 604 may be attached by attaching the first attachment portion 606 to the second attachment portion 608. The attachment portions may be hook and loop fasteners. The hook and loop fasteners may include tiny hooks, and loops. When the two components are pressed together, the hooks catch in the loops and the two pieces fasten or bind temporarily during the time that they are pressed together. One type of hook and loop fasteners are sold under the name Velcro. In one embodiment, the first attachment portion 606 may include loops and the second attachment portion 608 may include hooks. In one embodiment, the first attachment portion 606 may be a loop material on the underside of the section 602, and the second attachment portion 608 may be a hook material on the underside of section 604. In a second embodiment, the first attachment portion 606 may include hooks and the second attachment portion 608 may include loops. In a third embodiment, first attachment portion 606 may include hooks and loops and the second attachment portion 608 may include hooks and loops. The hooks and loops on the first attachment portion 606 engage the hooks and loops on the second attachment portion 608.

The attachment portions 606, 608 would be attached to the underside of the sections 602, 604. In one embodiment, the second attachment portion 608 may be attached vertically. In other embodiments, the second attachment portion may be attached horizontally, and/or at any angle between horizontal and vertical, or when there are multiple attachment portions, combinations of vertical, horizontal, or at an angle.

In one embodiment, the attachment portions 606, 608 may be attached to the sections by sewing. In other embodiments, the attachment portions 606, 608 may be attached by gluing, bonding, or other technique.

In other embodiments, a section may include one or more first attachment portions and one or more second attachment portions. In embodiments which include more than one attachment portion, the first attachment portions may be attached to their respective second attachment portions.

In one embodiment, a portion of section 604 may be placed under section 602 as noted above.

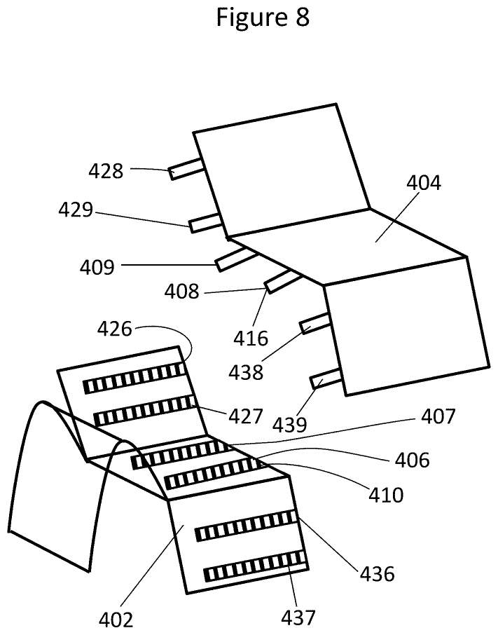

Referring to FIG. 13, another embodiment is shown for attaching the sections. The sections 702, 704 may include a first attachment portion 706 and a second attachment portion 708. The sections 702, 704 may be attached by attaching the first attachment portion 706 to the second attachment portion 708. The attachment portions may be hook and loop fasteners. The hook and loop fasteners may include tiny hooks, and loops. When the two components are pressed together, the hooks catch in the loops and the two pieces fasten or bind temporarily during the time that they are pressed together. One type of hook and loop fasteners are sold under the name Velcro. In one embodiment, the first attachment portion 706 may include loops and the second attachment portion 708 may include hooks. In one embodiment, the first attachment portion 706 may be a loop material on the underside of the section 702, and the second attachment portion 708 may be a hook material on the underside of section 704. In a second embodiment, the first attachment portion 706 may include hooks and the second attachment portion 708 may include loops. In a third embodiment, first attachment portion 706 may include hooks and loops and the second attachment portion 708 may include hooks and loops. The hooks and loops on the first attachment portion 706 engage the hooks and loops on the second attachment portion 708.

The attachment portions 706, 708 would be attached to the underside of the sections 702, 704. In one embodiment, the second attachment portion 708 may be attached horizontally. In other embodiments, the second attachment portion may be attached vertically, and/or at any angle between horizontal and vertical, or when there are multiple attachment portions, combinations of vertical, horizontal, or at an angle.

In one embodiment, the attachment portions 706, 708 may be attached to the sections by sewing. In other embodiments, the attachment portions 706, 708 may be attached by gluing, bonding, or other technique.

In other embodiments, a section may include one or more first attachment portions and one or more second attachment portions. A section may include one, two, three, four, five, six or more second attachment portions. In one embodiment, as shown in FIG. 13, a section may include second attachment portions 708, 728, 729, 738. In embodiments which include more than one attachment portion, the first attachment portions may be attached to their respective second attachment portions.

In one embodiment, a portion of section 704 may be placed under section 702 as noted above. In another embodiment, the sections 702, 704 may abut each other at their edges as noted above.

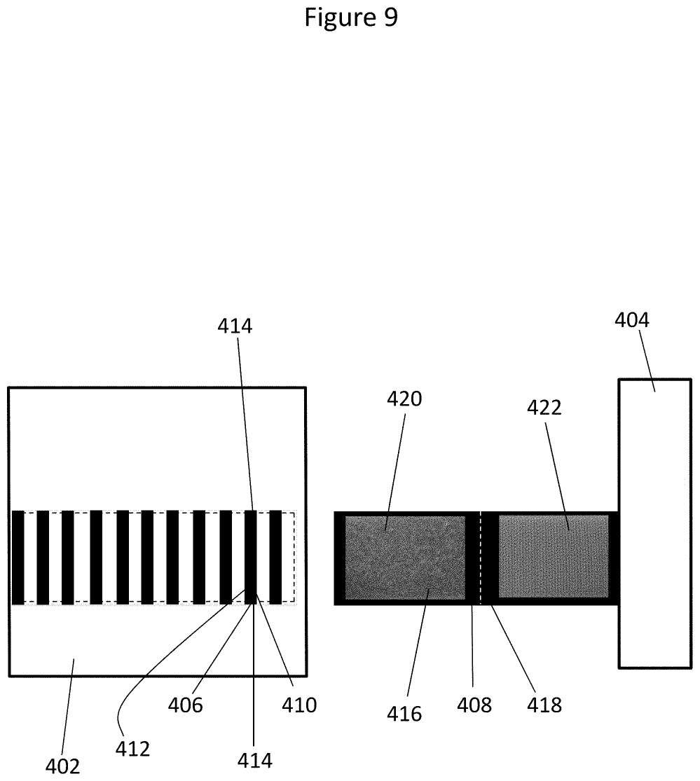

Referring to FIGS. 14 and 15, another embodiment is shown for attaching the sections. The sections 802, 804 may include a first attachment portion 806 and a second attachment portion 808. The sections 802, 804 may be attached by attaching the first attachment portion 806 to the second attachment portion 808. The attachment portions may be hook and loop fasteners. The hook and loop fasteners may include tiny hooks, and loops. When the two components are pressed together, the hooks catch in the loops and the two pieces fasten or bind temporarily during the time that they are pressed together. One type of hook and loop fasteners are sold under the name Velcro. In one embodiment, the first attachment portion 806 may include loops and the second attachment portion 808 may include hooks. In one embodiment, the first attachment portion 806 may be a loop material on the underside of the section 802, and the second attachment portion 808 may be a hook material. In one embodiment, the second attachment portion 808 may be a strip of hook material which is removably attached to the sections. In a second embodiment, the first attachment portion 806 may include hooks and the second attachment portion 808 may include loops. In a third embodiment, first attachment portion 806 may include hooks and loops and the second attachment portion 808 may include hooks and loops. The hooks and loops on the first attachment portion 806 engage the hooks and loops on the second attachment portion 808.

The attachment portions 806, 808 may be attached to the underside of the sections 802, 804. In one embodiment, the second attachment portion 808 may be attached vertically. In other embodiments, the second attachment portion may be attached horizontally, and/or at any angle between horizontal and vertical, or when there are multiple attachment portions, combinations of vertical, horizontal, or at an angle.

In one embodiment, the first attachment portions 806, may be attached to the sections by sewing. In other embodiments, the first attachment portions 806 may be attached by gluing, bonding, or other technique.

In other embodiments, a section may include one or more first attachment portions and one or more second attachment portions. A section may include one, two, three, four, five, six or more second attachment portions. In one embodiment, as shown in FIGS. 14 and 15, a section may include two second attachment portions 808, 828. In embodiments which include more than one attachment portion, the first attachment portions may be attached to their respective second attachment portions.

In one embodiment, a portion of section 804 may be placed under section 802 as noted above. In another embodiment, the sections 802, 804 may abut each other at their edges as noted above.

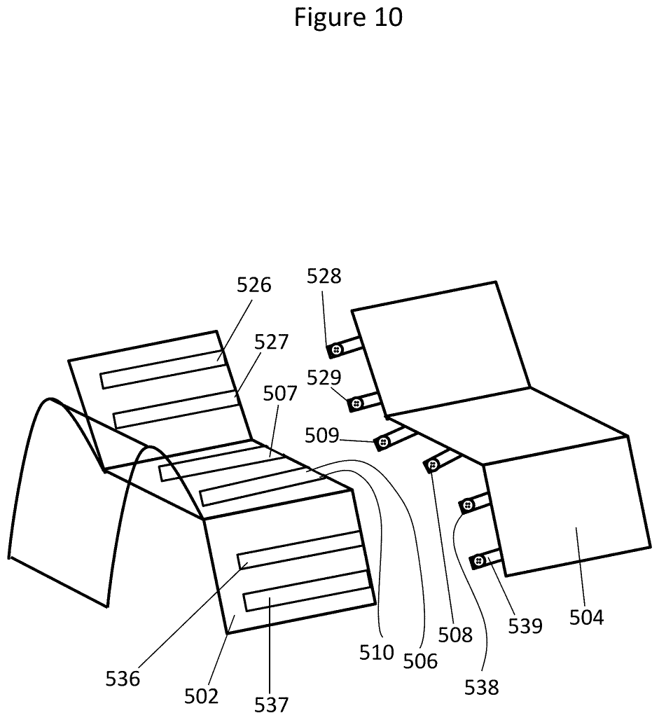

The protector may include sections of different shapes which may be attached to cover furniture of different shapes. One embodiment of combining the sections is shown in FIGS. 16 and 17. The protector 1000 may be used to protect a sectional sofa 1101. A sectional sofa 1101 may include several furniture sections which are arranged to form the sectional sofa.

In one embodiment, the protector 1000 may include a left arm section 1200, a right arm section 1300, two armless chair sections 1400, and a corner section 1500. The sections may be attached using the techniques and embodiments disclosed herein.

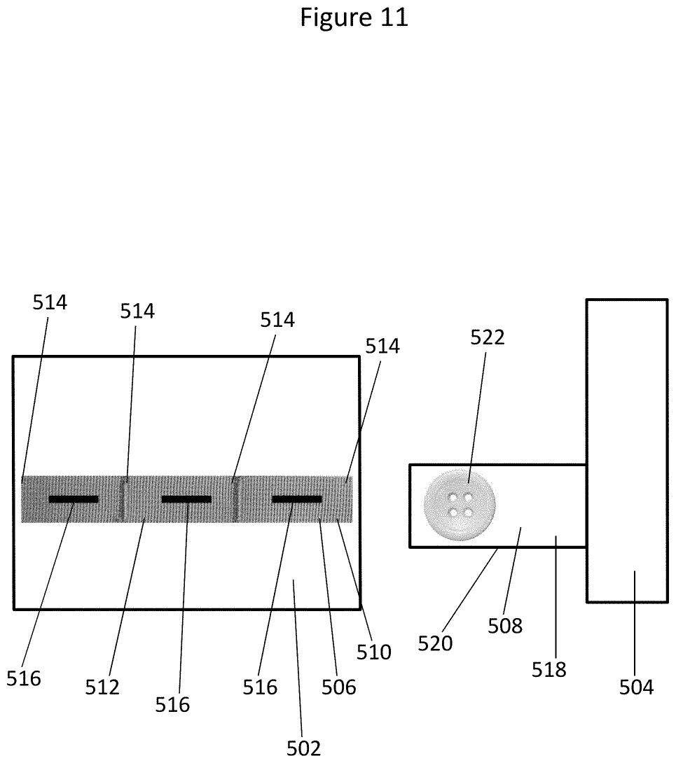

Referring to FIG. 18, a left arm section 1200 may include a seating panel 1202, a back panel 1204, and an arm rest panel 1206. In one embodiment, the seating panel 1202 may be attached to the back panel 1204. In one embodiment, the seating panel 1202 may be attached to the back panel 1204 by sewing at seam 1208. In other embodiments, the panels may be attached by gluing, bonding or other technique. In one embodiment, the arm rest panel 1206 may be attached to the seating panel 1202 and/or the back panel 1204. In one embodiment, the arm rest panel 1206 may be attached to the seating panel 1202 by sewing at seam 1210. In other embodiments, the panels may be attached by gluing, bonding or other technique.

In another embodiment, the left arm section 1200 may be one piece of material. In the one piece embodiment, the panels would not be attached at seams.

In another embodiment, the seating panel 1202 and the back panel 1204 may be one piece and the arm rest panel 1206 is attached at seam 1210. In an additional embodiment, the seating panel 1202 and the arm rest panel 1206 are one piece and the back panel 1204 is attached at seam 1208.

In one embodiment, the seating panel 1202 may cover the seating surface of the furniture. In one embodiment, the seating panel 1202 may include a seating portion 1221 and an extension portion 1223 as shown in FIGS. 16 and 18. The seating portion 1221 may cover the seating surface of the furniture. The extension portion 1223 may extend downward in front of the seating surface.

In one embodiment, the back panel 1204 may cover the back of the furniture. In one embodiment, the back panel 1204 may include a back portion 1231 and an extension portion 1233 as shown in FIGS. 16 and 18. The back portion 1231 may cover the back of the furniture. The extension portion 1233 may extend over the back of the furniture.

In one embodiment, the arm rest panel 1206 may cover the arm rest of the furniture. In one embodiment, the arm rest panel 1206 may include an arm portion 1241 and an extension portion 1243 as shown in FIGS. 16 and 18. The arm portion 1241 may cover the arm of the furniture. The extension portion 1243 may extend over the arm of the furniture.

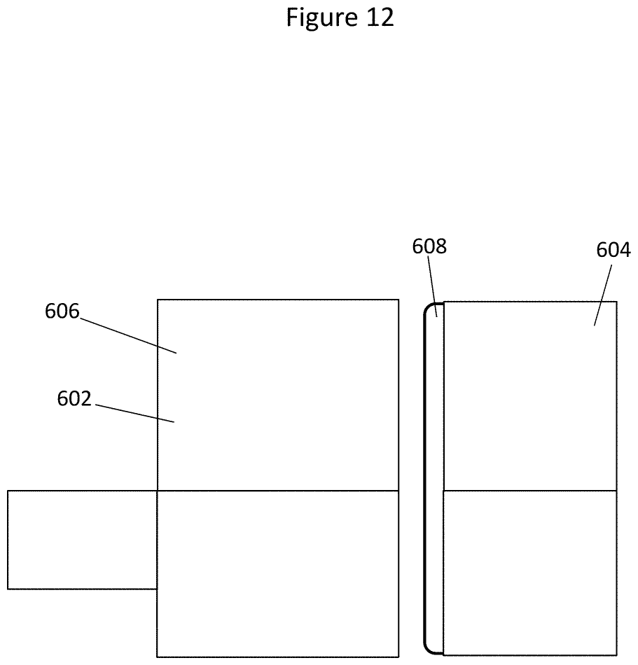

Referring to FIG. 19, the right arm section 1300 may be similar to the left arm section 1200. The right arm section 1300 may include a seating panel 1302, a back panel 1304, and an arm rest panel 1306. In one embodiment, the seating panel 1302 may be attached to the back panel 1304. In one embodiment, the seating panel 1302 may be attached to the back panel 1304 by sewing at seam 1308. In other embodiments, the panels may be attached by gluing, bonding or other technique. In one embodiment, the arm rest panel 1306 may be attached to the seating panel 1302 and/or the back panel 1304. In one embodiment, the arm rest panel 1306 may be attached to the seating panel 1302 by sewing at seam 1310. In other embodiments, the panels may be attached by gluing, bonding or other technique.

In another embodiment, the right arm section 1300 may be one piece of material. In the one piece embodiment, the panels would not be attached at seams.

In another embodiment, the seating panel 1302 and the back panel 1304 may be one piece and the arm rest panel 1306 is attached at seam 1310. In an additional embodiment, the seating panel 1302 and the arm rest panel 1306 are one piece and the back panel 1304 is attached at seam 1308.

In one embodiment, the seating panel 1302 may cover the seating surface of the furniture. In one embodiment, the seating panel 1302 may include a seating portion 1321 and an extension portion 1323 as shown in FIGS. 16 and 19. The seating portion 1321 may cover the seating surface of the furniture. The extension portion 1323 may extend downward in front of the seating surface.

In one embodiment, the back panel 1304 may cover the back of the furniture. In one embodiment, the back panel 1304 may include a back portion 1331 and an extension portion 1333 as shown in FIGS. 16 and 19. The back portion 1331 may cover the back of the furniture. The extension portion 1333 may extend over the back of the furniture.

In one embodiment, the arm rest panel 1306 may cover the arm rest of the furniture. In one embodiment, the arm rest panel 1306 may include an arm portion 1341 and an extension portion 1343 as shown in FIGS. 16 and 19. The arm portion 1341 may cover the arm of the furniture. The extension portion 1343 may extend over the arm of the furniture.

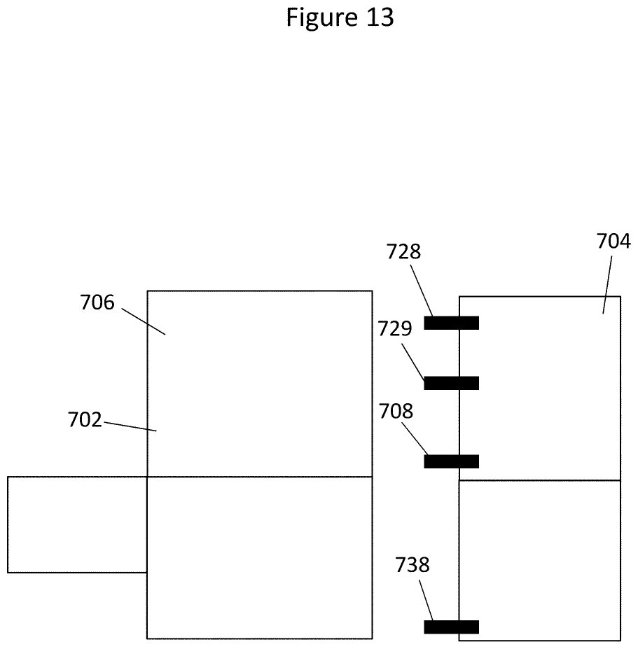

Referring to FIG. 20, the armless chair section 1400 may be similar to the left arm section 1200 or the right arm section 1300 except without the arm rest panel. The armless chair section 1400 may include a seating panel 1402, and a back panel 1404. In one embodiment, the seating panel 1402 may be attached to the back panel 1404. In one embodiment, the seating panel 1402 may be attached to the back panel 1404 by sewing at seam 1408. In other embodiments, the panels may be attached by gluing, bonding or other technique.

In another embodiment, the armless chair section 1400 may be one piece of material. In the one piece embodiment, the panels would not be attached at seams.

In one embodiment, the seating panel 1402 may cover the seating surface of the furniture. In one embodiment, the seating panel 1402 may include a seating portion 1421 and an extension portion 1423 as shown in FIGS. 16 and 20. The seating portion 1421 may cover the seating surface of the furniture. The extension portion 1423 may extend downward in front of the seating surface.

In one embodiment, the back panel 1404 may cover the back of the furniture. In one embodiment, the back panel 1404 may include a back portion 1431 and an extension portion 1433 as shown in FIGS. 16 and 20. The back portion 1431 may cover the back of the furniture. The extension portion 1433 may extend over the back of the furniture.

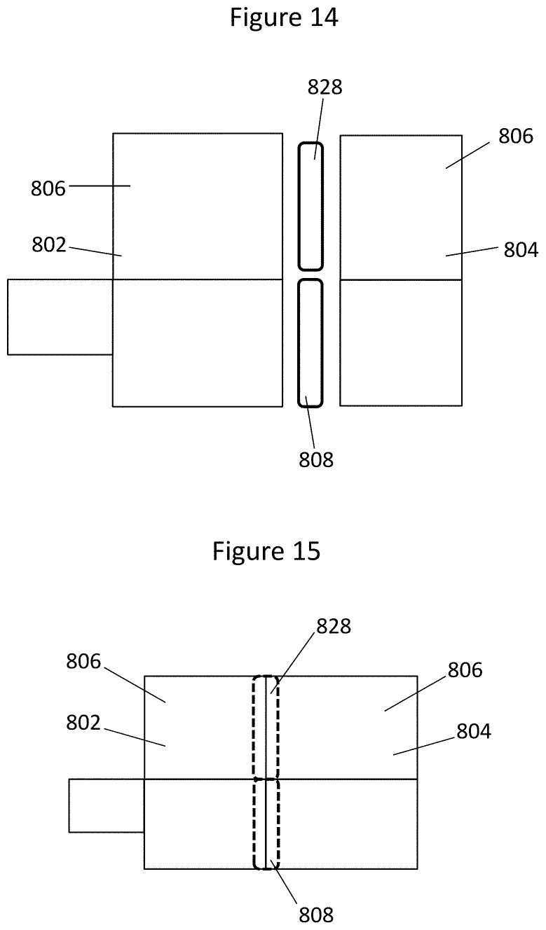

Referring to FIG. 21, the corner section 1500 may include a seating panel 1502, a first back panel 1504, and a second back panel 1505. In one embodiment, the seating panel 1502 may be attached to the first back panel 1504. In one embodiment, the seating panel 1502 may be attached to the first back panel 1504 by sewing at seam 1508. In other embodiments, the panels may be attached by gluing, bonding or other technique.

In one embodiment, the second back panel 1505 may be attached to the seating panel 1502 and/or the back panel 1504. In one embodiment, the second back panel 1505 may be attached to the seating panel 1502 by sewing at seam 1510. In other embodiments, the panels may be attached by gluing, bonding or other technique.

In another embodiment, the corner section 1500 may be one piece of material. In the one piece embodiment, the panels would not be attached at seams.

In another embodiment, the seating panel 1502 and the back panel 1504 may be one piece and the second back panel 1505 is attached at seam 1510. In an additional embodiment, the seating panel 1502 and the second back panel 1505 are one piece and the first back panel 1504 is attached at seam 1508.

In one embodiment, the seating panel 1502 may cover the seating surface of the furniture. In one embodiment, the seating panel 1502 may include a seating portion 1521, as shown in FIGS. 16 and 21. The seating portion 1521 may cover the seating surface of the furniture.

In one embodiment, the back panel 1504 may cover the back of the furniture. In one embodiment, the back panel 1504 may include a back portion 1531 and an extension portion 1533 as shown in FIGS. 16 and 21. The back portion 1531 may cover the back of the furniture. The extension portion 1533 may extend over the back of the furniture.

In one embodiment, the seating panel 1502 may include a notch 1535.

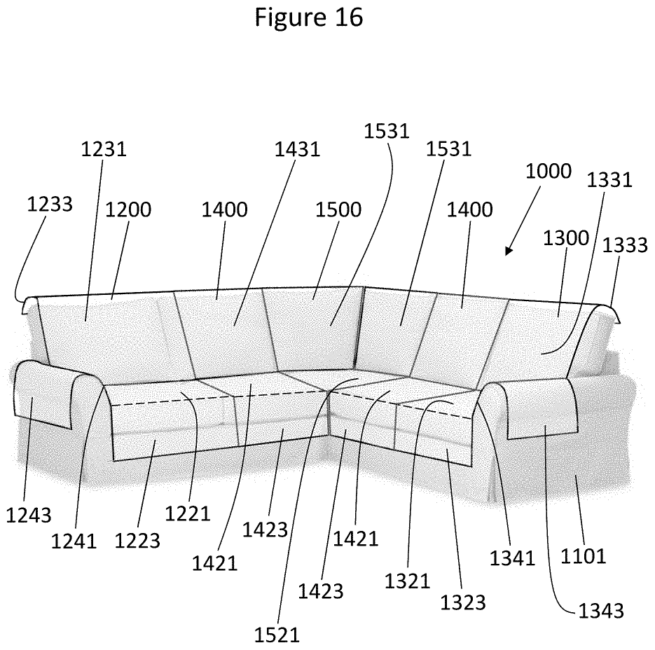

Referring to FIG. 22, an armless loveseat section 1600 is shown. The armless loveseat section 1600 is similar to the armless chair section 1400 except that the armless loveseat section 1600 is wider than the armless chair section 1400. The armless loveseat section 1600 may include a seating panel 1602, and a back panel 1604. In one embodiment, the seating panel 1602 may be attached to the back panel 1604. In one embodiment, the seating panel 1602 may be attached to the back panel 1604 by sewing at seam 1608. In other embodiments, the panels may be attached by gluing, bonding or other technique.

In another embodiment, the armless loveseat section 1600 may be one piece of material. In the one piece embodiment, the panels would not be attached at seams.

In one embodiment, the seating panel 1602 may cover the seating surface of the furniture. In one embodiment, the seating panel 1602 may include a seating portion 1621 and an extension portion 1623 as shown in FIG. 22. The seating portion 1621 may cover the seating surface of the furniture. The extension portion 1623 may extend downward in front of the seating surface.

In one embodiment, the back panel 1604 may cover the back of the furniture. In one embodiment, the back panel 1604 may include a back portion 1631 and an extension portion 1633 as shown in FIG. 22. The back portion 1631 may cover the back of the furniture. The extension portion 1633 may extend over the back of the furniture.

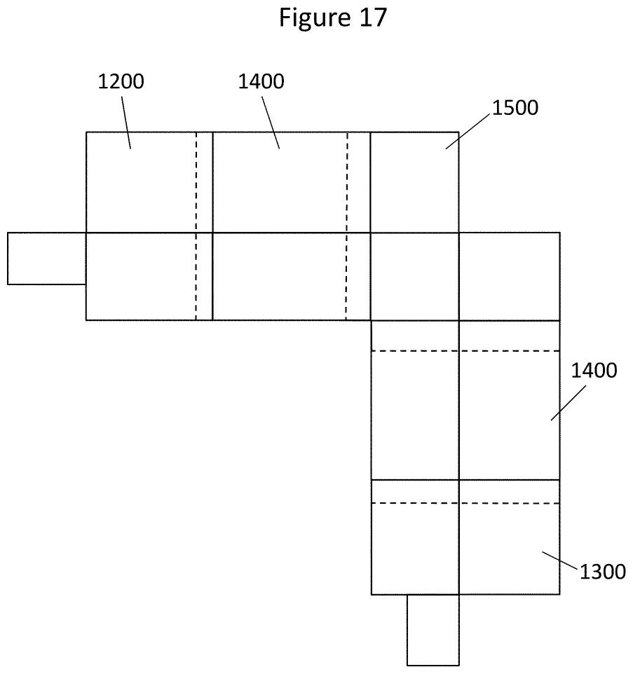

Referring to FIG. 23, an ottoman section 1700 is shown. The ottoman section 1700 may be used on an ottoman 1701. The ottoman section 1700 may include a seating panel 1702, a front panel 1704, a rear panel 1705, a first side panel 1706, and a second side panel 1707. In one embodiment, the seating panel 1702 may be attached to the front panel 1704, rear panel 1705, first side panel 1706, and second side panel 1707. In one embodiment, the seating panel 1702 may be attached to the front panel 1704, rear panel 1705, first side panel 1706, and second side panel 1707 by sewing at seams 1708, 1709, 1710, 1711. In other embodiments, the panels may be attached by gluing, bonding or other technique.

In another embodiment, the ottoman section 1700 may be one piece of material. In the one piece embodiment, the panels would not be attached at seams.

In another embodiment, the seating panel 1702 and the one or more of the panels 1704, 1705, 1706, 1707 may be one piece and one or more of the remaining panels is attached at a seam.

In one embodiment, the seating panel 1702 may cover the seating surface of the furniture. The front panel 1704, rear panel 1705, first side panel 1706 and second side panel 1707 may extend downward to cover side portions of the furniture. In other embodiments, one or more of the side panels may be attached to another section which is described herein.

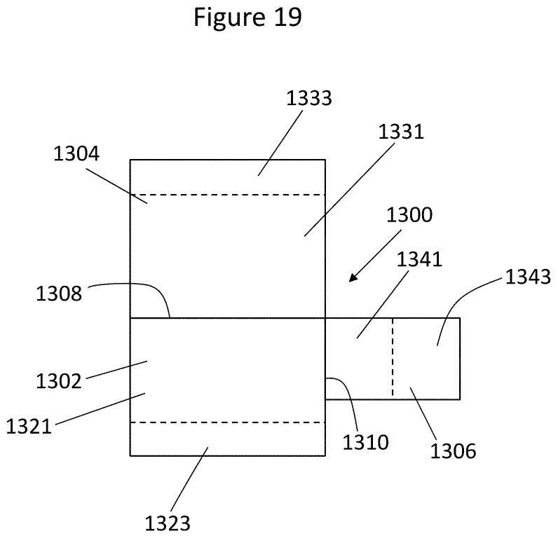

Referring to FIG. 25, another embodiment for combining the sections is shown. In one embodiment, the armless chair section 1400 may be attached to the ottoman section 1700. The sections may be attached using the techniques and embodiments disclosed herein. In one embodiment, the sections 1400, 1700 may be used on a left bumper 1801 of a sofa. In one embodiment, the one or more of the panels 1704, 1705, 1706, 1707 may be attached to the armless chair section 1400. The remaining panels of the ottoman section 1700 may extend downward.

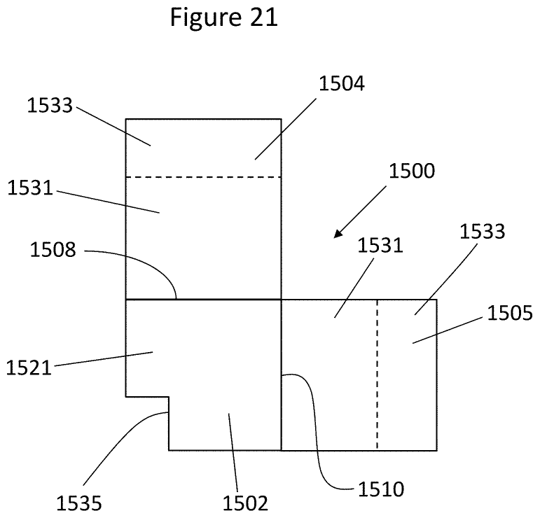

Referring to FIG. 27, another embodiment for combining the sections is shown. This embodiment is similar to the embodiments described for FIG. 25 except that the sections 1400, 1700 may be used on a right bumper 1901 of a sofa.

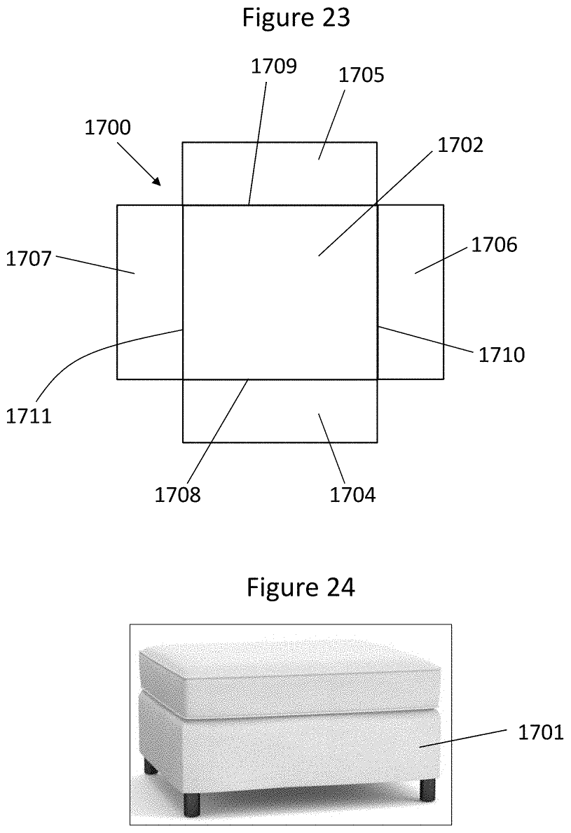

Referring to FIG. 29, another embodiment for combining the sections is shown. In one embodiment, the left arm section 1200 may be attached to the ottoman section 1700. The sections may be attached using the techniques and embodiments disclosed herein. In one embodiment, the sections 1200, 1700 may be used on a left arm chaise 2001 of a sofa. In one embodiment, the one or more of the panels 1704, 1705, 1706, 1707 may be attached to the left arm section 1200. The remaining panels of the ottoman section 1700 may extend downward.

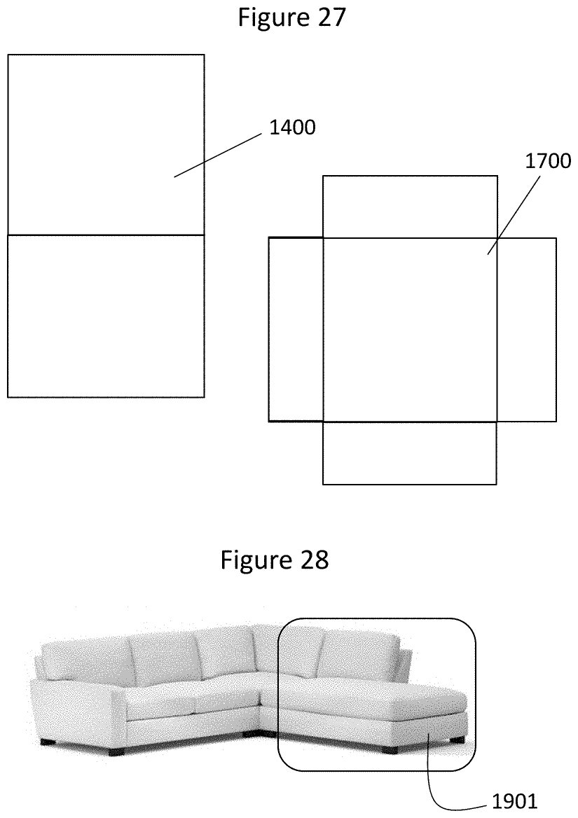

Referring to FIG. 31, another embodiment for combining the sections is shown. This embodiment is similar to the embodiments described for FIG. 29 except that the right arm section 1300 and the ottoman section 1700 may be used on a right arm chaise 2101 of a sofa.

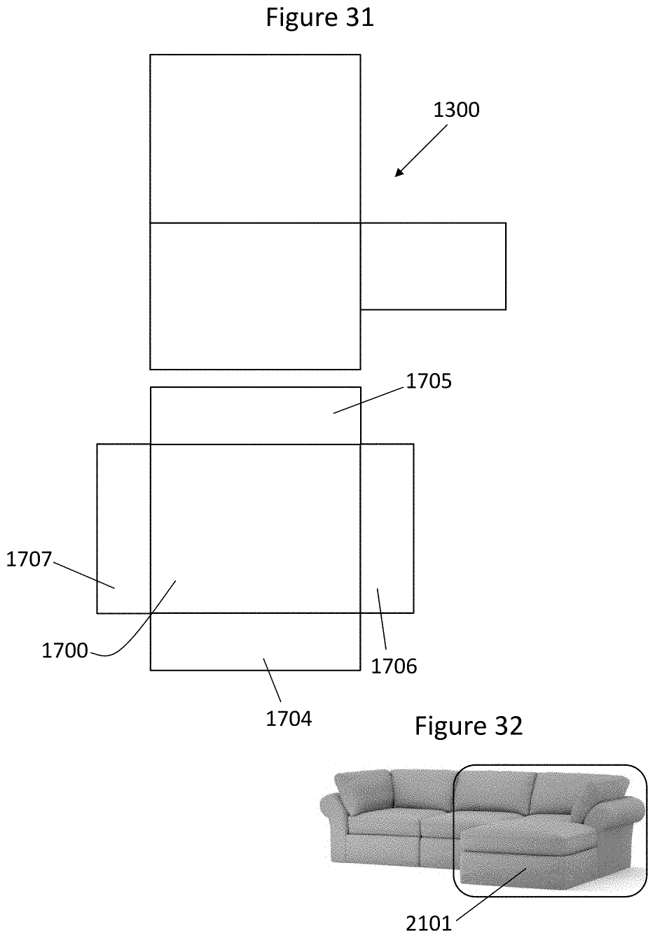

Referring to FIGS. 33 and 34, another embodiment for combining the sections is shown. The protector 2200 may be used to protect a sofa 2201. In one embodiment, the protector 2200 may include a left arm section 1200, a right arm section 1300, and an armless chair section 1400. The sections may be attached using the techniques and embodiments disclosed herein. In other embodiments, depending upon the length of the sofa, the protector may include one or more armless chair sections 1400, and/or one or more armless loveseat sections 1600.

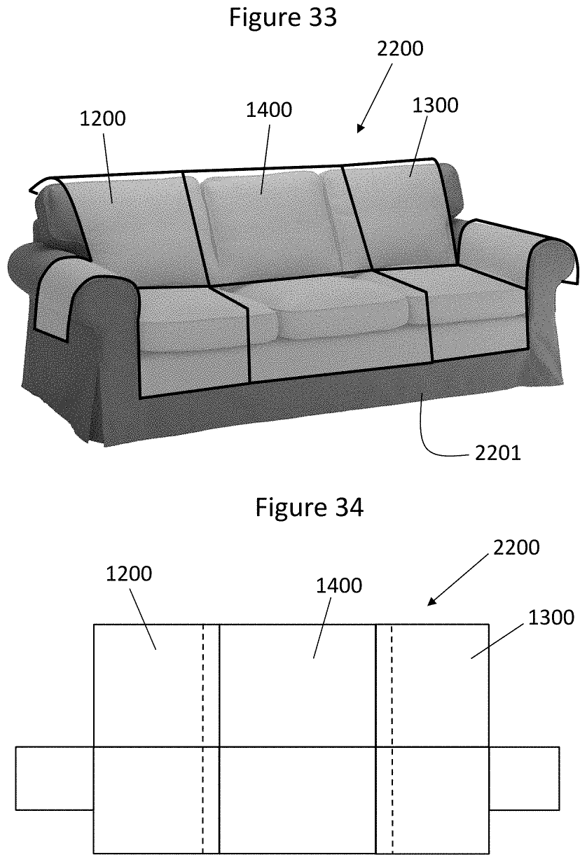

Referring to FIGS. 35 and 36, another embodiment for combining the sections is shown. The protector 2300 may be used to protect a sofa 2301. In one embodiment, the protector 2300 may include a left arm section 1200, and a right arm section 1300. The sections may be attached using the techniques and embodiments disclosed herein.

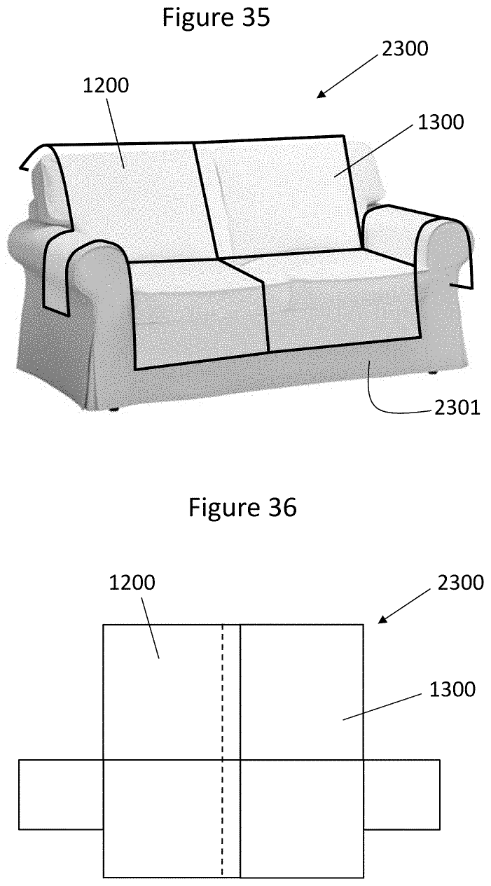

The sections may include a retention portion to hold the protector and sections onto the furniture. Referring to FIG. 37, one embodiment of a retention portion 2460 is shown. In one embodiment, the retention portion 2460 may be a loop 2462. The loop 2462 may be attached to the section 2402. The loop 2462 may include a material 2420 which is attached to the underside of the section 2402. In one embodiment, the material 2420 may be attached by sewing. In other embodiments, the material may be attached by gluing, bonding, or other technique. The material 2420 may be made of cloth, webbing material, strapping material, or other material.

In one embodiment, the loop 2462 may include a grip portion 2464. The grip portion 2464 may be attached to the material 2420. In one embodiment, the grip portion 2464 may be a tubular portion of material which is positioned around the material. In one embodiment, the grip portion 2464 may be a tubular handle portion. In other embodiments, the grip portion may be attached to the material by sewing, gluing, bonding, the tube encased within the webbing, or other technique. The grip portion 2464 may be made of rubber, plastic, polypropylene, polyethylene, or other material.

A section may include one, two, three, four, or more retention portions 2460. The retention portions may be positioned at various locations on the section. The retention portion 2460 may be inserted between two cushions, between a cushion and the arm rest, between a cushion and the back rest, and/or between other portions of the furniture.

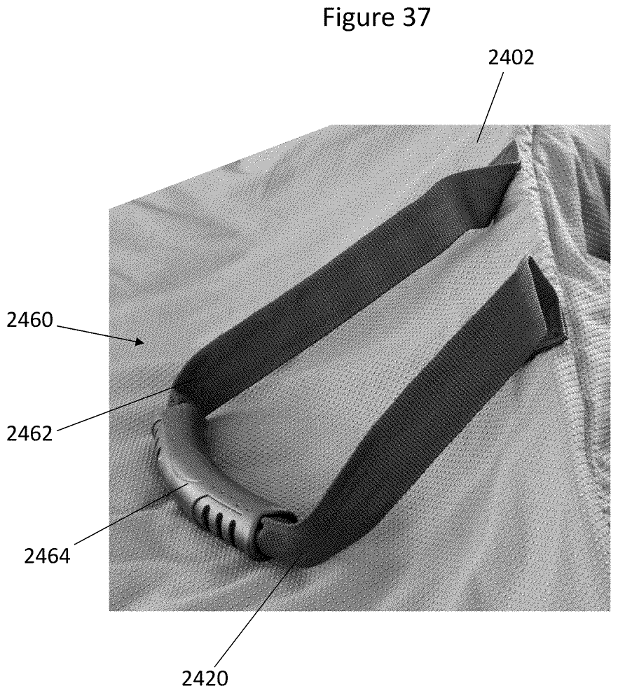

Another embodiment of a retention portion is shown in FIG. 38. In one embodiment, the retention portion 2560 may be a tie 2562. The tie 2562 may be material 2517 that can be tied in a bow, or knot. The material 2517 may be made of cloth, webbing material, strapping material, or other material. In one embodiment, the tie 2562 may include a first tie 2518 and a second tie 2520. The first tie 2518 and second tie 2520 may be tied into a knot to hold the section onto the furniture. The ties 2518, 2520 may be attached to section 2502. In one embodiment, the ties 2518, 2520 may be attached by sewing. In other embodiments, the ties may be attached by gluing, bonding, or other technique.

A section may include one or more retention portions. In one embodiment as shown in FIG. 38, a section may include first retention portion 2560 and second retention portion 2568. In one embodiment, the second retention portion 2568 may be the same as the first retention portion 2560. In another embodiment, the second retention portion 2568 may be different than the first retention portion 2560.

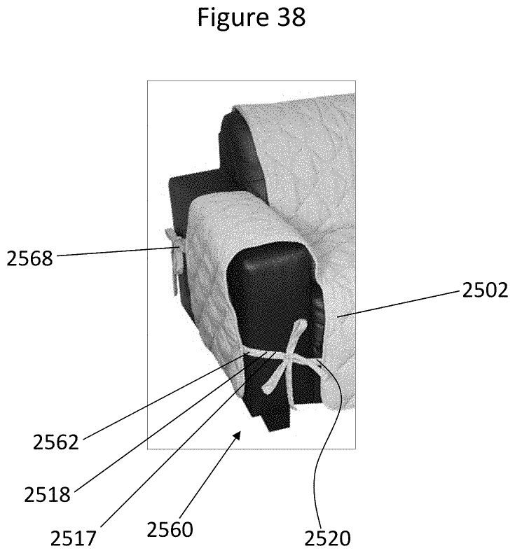

The section may include one or more layers. One embodiment is shown in FIG. 39. The section 2602 may include a first layer 2680, a second layer 2682, and a third layer 2684.

The first layer 2680 may be made from a broad range of materials. These materials include, but are not limited to, polyester fabric, nylon fabric, woven and knitted fabric, leathers, fleece, and microfiber fabrics. In one embodiment, the first layer 2680 may be quilted. In one embodiment, the first layer 2680 may have coatings for water repellency, stain resistance, anti-static, and/or anti-microbial.

In one embodiment, the second layer 2682 may be a waterproof breathable membrane.

In one embodiment, the third layer 2684 may be made from a broad range of materials. These materials include, but are not limited to, polyester fabric, nylon fabric, woven and knitted fabric, fleece, and microfiber fabrics. In one embodiment, the third layer may be a loop fabric or hook fabric as discussed herein. In one embodiment, the third layer 2684 may include or may be coated with non-slip, anti-skid, or gripper properties.

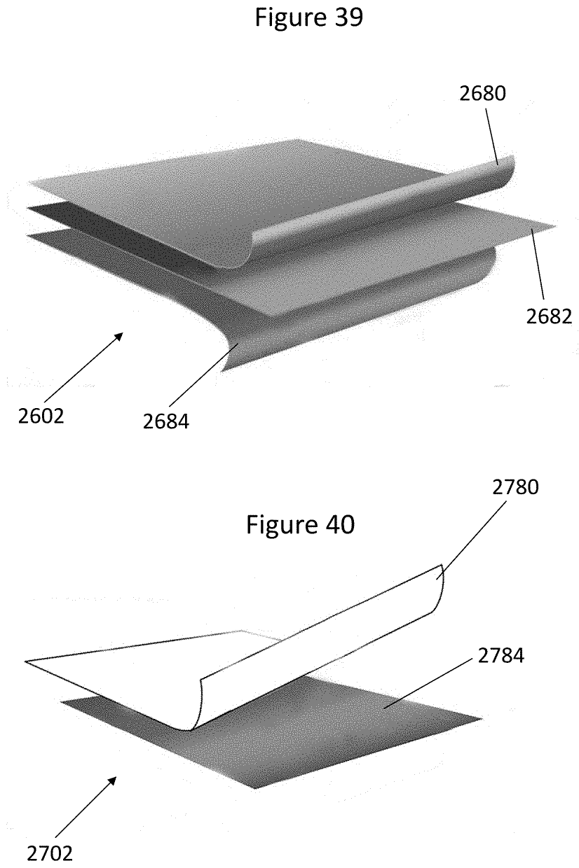

Another embodiment of a section is shown in FIG. 40. The section 2702 may include a first layer 2780 and a second layer 2784. The first layer 2780 may be made from a broad range of materials. These materials include, but are not limited to, polyester fabric, nylon fabric, woven and knitted fabric, leathers, fleece, and microfiber fabrics. In one embodiment, the first layer 2780 may be quilted. In one embodiment, the first layer 2780 may have coatings for water repellency, stain resistance, anti-static, and/or anti-microbial.

In one embodiment, the second layer 2784 may be made from a broad range of materials. These materials include, but are not limited to, polyester fabric, nylon fabric, woven and knitted fabric, fleece, and microfiber fabrics. In one embodiment, the second layer may be a loop fabric or hook fabric as discussed herein. In one embodiment, the second layer 2784 may include or may be coated with non-slip, anti-skid, or gripper properties.

In other embodiments, a section may include 1, 4, 5, 6 or more layers.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A protector for furniture comprising:
a first section, the first section is made of a material which will protect the furniture from stains and wear, the first section includes a first attachment portion;
a second section, the second section is made of a material which will protect the furniture from stains and wear, the second section includes a second attachment portion;
the first section is removably attached to the second section by attaching the first attachment portion and the second attachment portion.

2. The protector as in claim 1 wherein the first attachment portion includes a daisy chain and the second attachment portion includes a tie.

3. The protector as in claim 1 wherein the first attachment portion includes a daisy chain and the second attachment portion includes a side release buckle.

4. The protector as in claim 1 wherein the first attachment portion includes a button hole and the second attachment portion includes a button.

5. The protector as in claim 1 wherein at least one of the first attachment portion or the second attachment portion include a hook and loop fastener.

6. The protector as in claim 1 wherein the first attachment portion includes a loop material and the second attachment portion includes a hook material.

7. The protector as in claim 1 wherein the first attachment portion includes a combination hook and loop material and the second attachment portion includes a combination hook and loop material.

8. The protector as in claim 1 wherein a portion of the first section overlaps a portion of the second section.

9. The protector as in claim 1 wherein an edge of the first section abuts an edge of the second section.

10. The protector as in claim 1 wherein the first section includes a seating panel and a back panel.

11. The protector as in claim 1 wherein the first section includes an arm rest panel.

12. The protector as in claim 10 wherein the seating panel includes a seat portion and an extension portion.

13. The protector as in claim 10 wherein the back panel includes a back portion and an extension portion.

14. The protector as in claim 11 wherein the arm rest panel includes an arm portion and an extension portion.

15. The protector as in claim 1 wherein the first section includes a retention portion.

16. The protector as in claim 15 wherein the retention portion is a loop.

17. The protector as in claim 15 wherein the retention portion is a tie.

18. The protector as in claim 1 wherein the first section includes a first layer.

19. The protector as in claim 18 wherein the first section includes a second layer.

20. The protector as in claim 19 wherein the first section includes a third layer.
